(19) United States
(12) Patent Application Publication
(10) Pub. No.: US 2003/0092435 A1
(43) Pub. Date: May 15, 2003

(54) System and method to automatically activate a recyclable/disposable telephone using a point-of-sale terminal

(76) Inventor: Roger Boivin, Melissa, TX (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/290,176

(22) Filed: Nov. 8, 2002

Related U.S. Application Data
(60) Provisional application No. 60/331,114, filed on Nov. 9, 2001.

(51) Int. Cl. H04M 3/00

(52) U.S. Cl. 455/419

(57) ABSTRACT

A system and method for automatically activating a recyclable/disposable telephone using a point-of-sale terminal at a vendor's location and a connection to a carrier's server database system is more convenient and less costly than conventional techniques. A system for activating a mobile telephone comprises of a universal product code or an activation card associated with the mobile telephone, containing activation information needed to activate the mobile telephone, a point-of sale terminal operable to scan the universal product code or activation card associated with the mobile telephone to obtain the activation information, and a point-of-sale central computer operable to forward the activation information to a server database system in order to activate the mobile telephone.

### CROSS-REFERENCE TO RELATED APPLICATIONS

The benefit under 35 U.S.C. § 119(e) of provisional application No. 60/331,114, filed Nov. 9, 2001, is hereby claimed.

### FIELD OF THE INVENTION

The present invention relates to a system and method to automatically activate a recyclable/disposable telephone using a point-of-sale terminal at a vendor's location and a connection to a server database system.

### BACKGROUND OF THE INVENTION

Mobile telecommunications, such as that provided by wireless telephones, has become increasingly popular and widespread. With this increasing popularity has come a proliferation of mobile telephone plans, with a proliferation of fees, features, and restrictions. Most such plans require a relatively large initial investment and a continuing monthly fee, regardless of usage. While such plans may meet the needs of many users, they do not meet the needs of many other users. For example, a user may desire a mobile telephone to be available for emergency use only. Likewise, a user may desire short-term service for themselves while on a trip or for visitors while being visited. These uses are not really compatible with the typical initial investment and continuing fee required by most mobile telephone plans. In these and many other situations, a need arises for a mobile telephone that requires a reasonable initial investment and no continuing fee.

Conventional solutions to such needs include pay-per-use, prepaid, and rental mobile telephones. However, these solutions have disadvantages in that they typically still require relatively large initial investments, contracts, and/or deposits on the part of the user. A better solution is the recyclable/disposable mobile telephone, which requires only a reasonable initial investment by the user and does not require contracts or deposits.

A problem arises with recyclable/disposable mobile telephones in that when such a telephone is purchased, it must be activated before it can be used. Conventional activation schemes typically require significant effort vendor and/or carrier personnel to activate the telephone. This is inconvenient for the user of the telephone and costly for the vendor and carrier. A need arises for a more convenient and less costly way to activate recyclable/disposable mobile telephones.

### SUMMARY OF THE INVENTION

The present invention is a system and method for automatically activating a recyclable/disposable telephone using a point-of-sale terminal at a vendor's location and a connection to a server database system that is more convenient, faster and less costly than conventional techniques. In one embodiment of the present invention, a system for activating a mobile telephone comprises universal product code or an activation card associated with the mobile telephone, the activation card containing activation information needed to activate the mobile telephone, a point-of sale terminal operable to scan universal product code or the activation card associated with the mobile telephone to obtain the activation information, and a point-of-sale central computer operable to forward the activation information to a server database system in order to activate the mobile telephone. The mobile telephone may be a recyclable/disposable telephone.

In one aspect of the present invention, the information needed to activate the mobile telephone comprises information identifying the mobile telephone and routing information. The information identifying the mobile telephone may comprise a Mobile Identification Number. The information needed to activate the mobile telephone may further comprise information relating to a price paid to purchase the mobile telephone. The point-of-sale terminal may be operated by a vendor of the mobile telephone. The point-of-sale central computer may be operated by a vendor of the mobile telephone or an independent third party.

In one aspect of the present invention, the activation information comprises the Mobile Identification Number. The point-of-sale central computer may be operable to forward the activation information using the routing information. The point-of-sale terminal may be operated by a vendor of the mobile telephone. The point-of-sale central computer may be operated by a vendor of the mobile telephone or an independent third party.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical mobile communications network, which may function in conjunction with the present invention.

FIG. 2 is an exemplary block diagram of a mobile communications network, in which the present invention may be implemented.

FIG. 3 is an exemplary flow diagram of a process of operation of the present invention.

FIG. 4 is an exemplary block diagram of a server system shown in FIG. 2.

### DETAILED DESCRIPTION OF THE INVENTION

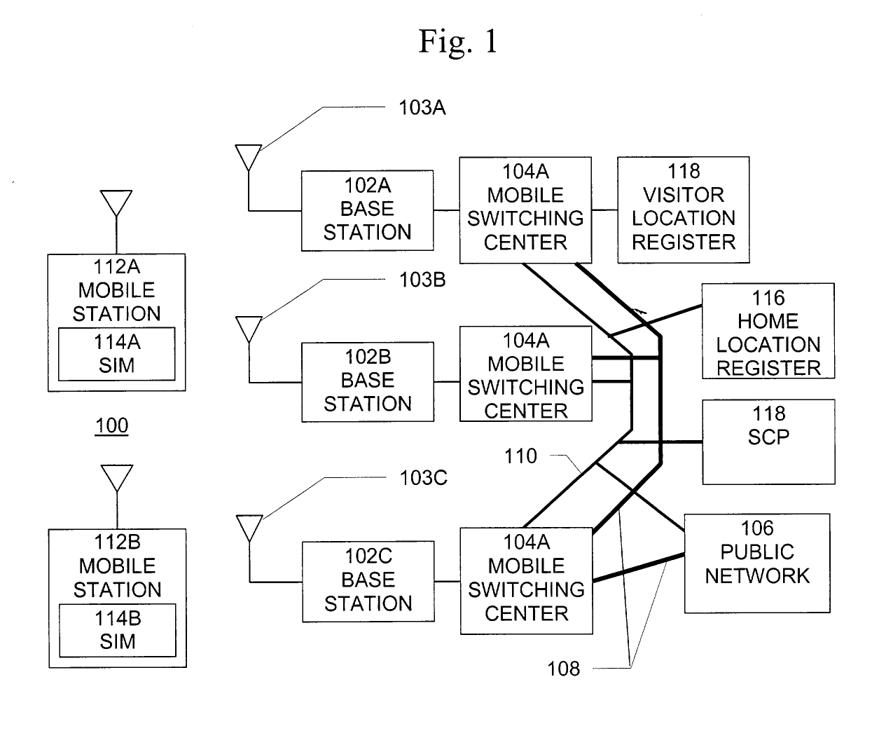

An exemplary block diagram of a typical mobile communications network 100, which may function in conjunction with the present invention, is shown in FIG. 1. Such a mobile network includes a plurality of base stations, such as base stations 102A-C. Each base station, such as base station 102A, typically includes a plurality of base station transceivers, which are part of a base station cluster controlled by a single base station controller. Each base station transceiver transmits and receives radio signals on its corresponding antenna 103A-C and each such transceiver antenna unit covers an area known as a cell. For much of the network, base station transceivers are organized in a seven cell or twelve cell repeat pattern with omni-directional coverage for each. Thus, seven or twelve base station transceivers are typically connected to each base station controller. Most base station transceivers have between 20 and 30 voice channels with one signaling channel carrying all of the paging and access functions per cell.

Each base station, such as base station 102A, is connected to a mobile switching center (MSC), such as MSC 104A. MSC 104A is a digital switching system with a distributed control architecture especially adapted for operation in the cellular environment. The base stations 102A-C are typically connected to their corresponding MSCs 104A-C and the public (landline) telephone network 106 over digital lines 108. The MSCs 104A-C handle the switching of call traffic between base stations and the landline telephone network, public network 106. MSCs 104A-C are also connected by a signaling network 110, over which a variety of signaling messages are communicated.

The system also includes a plurality of mobile telephones, such as mobile telephones 112A-B, which receive and transmit radio signals with the antenna 103A-C of the base station 102A-C with which the mobile telephone is communicating. Each mobile telephone 112A-B may include a subscriber identity module (SIM), such as SIM 114A-B. Designed to be inserted into a mobile telephone, a SIM or “smart” card contains subscriber-related data, such as phone numbers, service details, and memory for storing messages. With a SIM card, calls can be made from any valid mobile phone because the subscriber data—not the telephone's internal serial number—is used to make the call

Associated with mobile communications network 100 is home location register (HLR) 116. HLR 116 stores management data relating to all of the mobile telephones 112A-B for which network 100 is the home network. Each MSC 104A-C is associated with an HLR 116 in the network. In principle there need be only one HLR 116 for the entire mobile network. In practice, there are generally several so as to accommodate the large quantity of data, which is required to be stored in the HLR 116. This data includes the international mobile station identity (IMSI), the mobile station profile of capacities and services unique to the mobile telephone 112A-B, and the location of the mobile telephone 112A-B within the overall mobile network. HLR 116 is connected over signaling network 110 to the MSCs 104A-C in the network.

Associated with each MSC 104A-C is a visitor location register (VLR) 118. Each MSC 104A-C typically has its own VLR 118, but this is not required. VLR 118 stores selected data relating to mobile telephones 112A-B that are visiting within the network associated with VLR 118 and its MSC 104A-C. The data stored in VLR 118 is transferred from the home location register of the home network to VLR 118 for each mobile telephone 112A-B within the network of the VLR. This data can include the international mobile station identity (IMSI), the mobile station international ISDN number, and other information, including the current geographic location of the mobile telephone 112A-B, and the services available to the mobile telephone 112A-B, for example supplementary voice services or data services.

The VLR servicing a geographic area is continually updated with the locations of every mobile telephone within its service area as each mobile telephone registers or otherwise communicates with the system. In addition, the HLR is updated with the current serving MSC of each active mobile telephone allocated to it. This location is typically in the form of the particular cell—base station, base station transceiver, and antenna—in which the mobile telephone is located.

Mobile network 100 may also include service control point (SCP) 118. SCP 118 is a database that supplies the translation and routing data needed to provide advanced network services in signaling network 110. SCP 118 translates special service numbers, such as 800 numbers, to provide the required routing number.

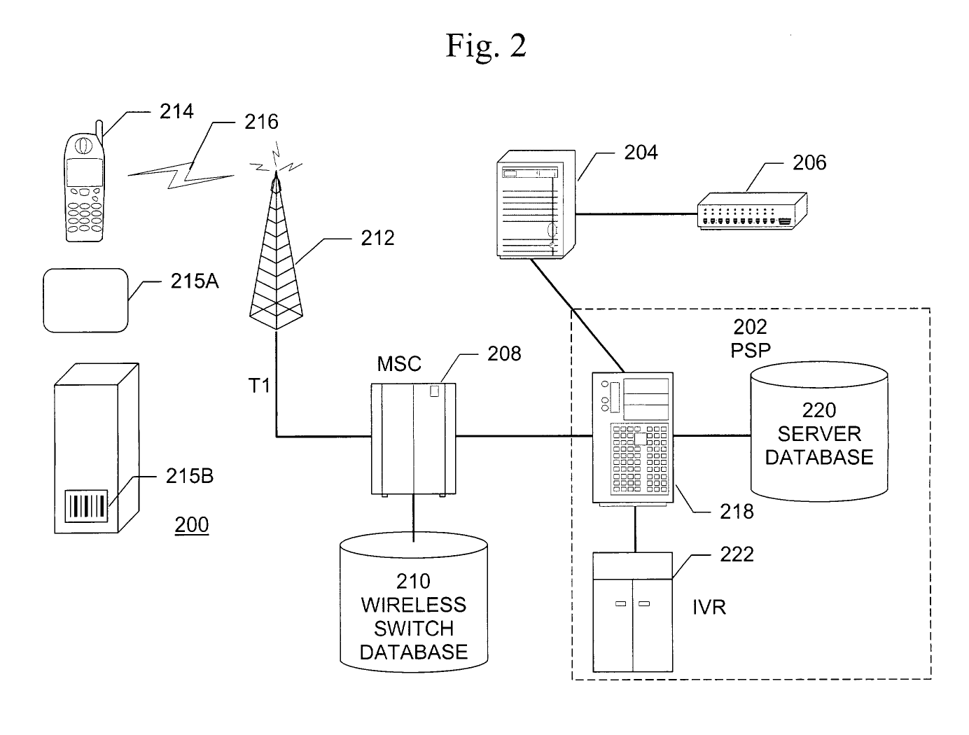

An exemplary block diagram of a mobile communications network 200, in which the present invention may be implemented, is shown in FIG. 2. Network 200 includes prepaid server platform (PSP) 202, point-of-sale (POS) central computer 204, POS terminal 206, mobile switching center (MSC) 208, wireless switch database 210, base station 212, and mobile telephone 214. Associated with mobile telephone 214 is activation card 215A and/or universal product code (UPC) 215B, which is typically attached to the packaging of mobile telephone 214.

The network shown in FIG. 2 is merely an example. One of skill in the art would recognize that a network in which the present invention may be implemented may include multiple instances of elements shown in FIG. 2, as well as additional elements, such as those shown in FIG. 1.

Mobile telephone 214 receives and transmits radio signals over radio frequency link 216 with the antenna of the base station 212 with which the mobile telephone is communicating. Preferably, mobile telephone 214 is a disposable/recyclable wireless or cellular telephone (RDP) and will be referred to as such for this example.

Base station 212 is connected to MSC 208. MSC 208 is a digital switching system with a distributed control architecture especially adapted for operation in the cellular environment. Base stations 212 is typically connected MSC 208 over digital lines, such as a T1 line. MSC 208 handles the switching of call traffic between base station 212 and PSP 202.

MSC 208 is connected to wireless switch database 210 and PSP 202. PSP 202 includes prepaid service server 218, server database system 220, and interactive voice response (IVR) unit 222. Server 218 handles calls placed between mobile telephone 214 and PSTN 204. Server database system 220 stores data needed by server 218 in order to handle the calls and perform the appropriate billing. IVR 222 provides interactive voice response to callers in order to facilitate the handling of calls by server 218. As one of skill in the art would recognize, server database system 220 and/or IVR 222 may be included in server 218, or they may be implemented separately from server 218. The present invention contemplates any and all such arrangements.

POS central computer 204 is connected to server database system 220 and POS terminal 206 is connected to POS central computer 204. POS terminal 206 scans activation card 215A or UPC 215B that is associated with mobile telephone 214 and reads the information encoded on activation card 215A or UPC 215B. POS terminal 206 transmits the information from activation card 215 to POS central computer 204. POS central computer 204 forwards an activation message based on the information encoded on activation card 215A or UPC 215B and transmits the activation message to server database system 220.

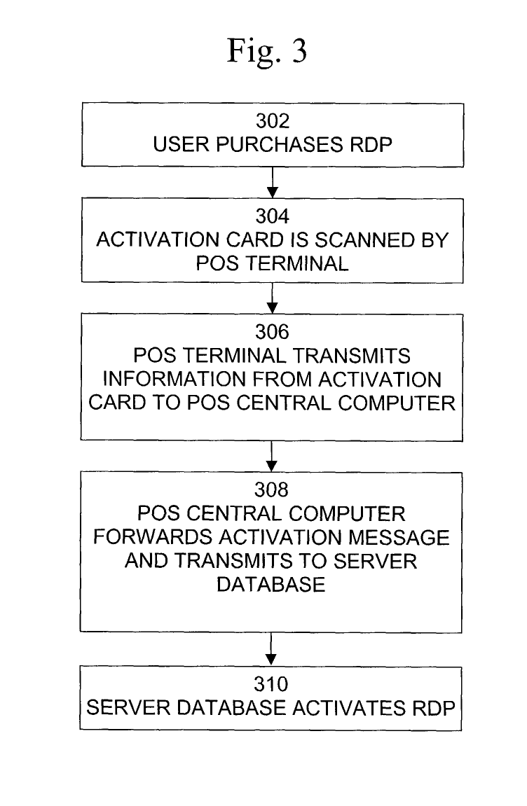

An exemplary flow diagram of a process 300 of operation of the present invention is shown in FIG. 3. It is best viewed in conjunction with FIG. 2. Process 300 begins with step 302, in which a user purchases a recyclable/disposable telephone, such as RDP 214. Associated with RDP 214 is either activation card 215A or UPC 215B. Typically, activation card 215 is packaged with RDP 214, or is otherwise attached to RDP 214 or the packaging of RDP 214. Likewise, UPC 215B is typically attached to the packaging of RDP 214. Activation card 215A includes information needed to activate RDP 214. In particular, activation card 215A includes a mobile identification number (MIN) of RDP 214 and routing information that will be used to route an activation message to the server database system 220. UPC 215B also includes information needed to activate RDP 214. UPC 215B may include a mobile identification number (MIN) of RDP 214 and routing information that will be used to route an activation message to the server database system 220. Alternatively, UPC 215B will include a reference to information that is stored in server database system 220, which will be used to activate RDP 214.

In step 304, activation card 215A or UPC 215B is scanned by POS terminal 206, which reads the information encoded therein. If activation card 215A or UPC 215B includes the MIN and routing information, POS terminal 206 reads the MIN and routing information from activation card 215A or UPC 215B. Otherwise, POS terminal 206 reads the reference information. In step 306, POS terminal 206 transmits information that was read activation card 215A or UPC 215B to POS central computer 204. In step 308, POS central computer receives the information that was read activation card 215A or UPC 215B from POS terminal 206 and forwards an activation message including the received information. If the information that was read activation card 215A or UPC 215B includes the MIN and routing information, then the activation message includes the MIN. Otherwise, the message includes the reference information. POS central computer 204 transmits the activation message to server database system 220 using the routing information. In step 310, server database system 220 receives the activation message and activates the RDP identified by the MIN or the reference information, which is RDP 214.

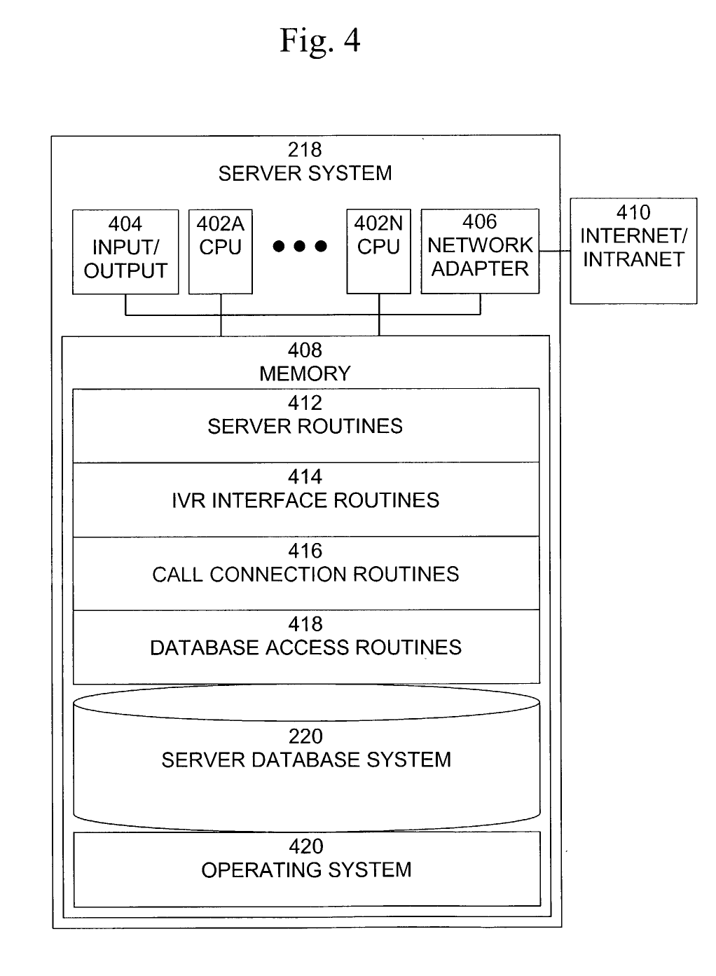

An exemplary block diagram of a server system 400 shown in FIG. 2, is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which System 400 is implemented as a plurality of networked computer systems, which may be single-processor computer systems, multi-processor computer systems, or a mix thereof.

Input/output circuitry 404 provides the capability to input data to, or output data from, database/System 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces database/System 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 4, memory 408 includes server routines 412, IVR interface routines 414, call connection routines 416, database access routines 418, and operating system 428. Server system 218 may also include server database system 220. one of skill in the art would recognize that these functions, along with the memory contents related to those functions, may be included on one system, or may be distributed among a plurality of systems, based on well-known engineering considerations. The present invention contemplates any and all such arrangements. For example, server database system 220 and/or IVR 222 may be included in server 218, or they may be implemented separately from server 218.

Server routines 412 include software that implements the functionality of prepaid server platform 202, shown in FIG. 1. IVR interface routines 414 provide the capability to interface an IVR, such as IVR 222, with server system 218 and to interoperate with the IVR. Call connection routines 416 provide the capability to connect calls with mobile telephones, such as RDP 214, in order to perform process 300, shown in FIG. 3. Database access routines provide the capability to access server database system 220, in order to perform process 300. Operating system 420 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for activating a mobile telephone comprising the steps of:
scanning a universal product code or an activation card associated with the mobile telephone to obtain activation information needed to activate the mobile telephone;
forwarding the activation information to a server database system; and
activating the mobile telephone at the server database system.

2. The method of claim 1, wherein the mobile telephone is a recyclable/disposable telephone.

3. The method of claim 2, wherein the information needed to activate the mobile telephone comprises:
information identifying the mobile telephone; and
routing information.

4. The method of claim 3, wherein the information needed to activate the mobile telephone further comprises:
information relating to a price paid to purchase the mobile telephone.

5. The method of claim 3, wherein the information identifying the mobile telephone comprises a Mobile Identification Number.

6. The method of claim 5, wherein the step of scanning a universal product code or an activation card is performed by a point-of-sale terminal.

7. The method of claim 6, wherein the point-of-sale terminal is operated by a vendor of the mobile telephone.

8. The method of claim 7, wherein the step of forwarding the activation information to a server database system is performed by a point-of-sale central computer.

9. The method of claim 8, wherein the point-of-sale central computer is operated by a vendor of the mobile telephone or an independent third party.

10. The method of claim 3, wherein the step of forwarding the activation information comprises the step of:
transmitting an activation message comprising the Mobile Identification Number.

11. The method of claim 10, wherein the step of transmitting the activation message comprises the step of:
transmitting the activation message to the server database system using the routing information.

12. The method of claim 11, wherein the step of scanning the universal product code or an activation card is performed by a point-of-sale terminal.

13. The method of claim 12, wherein the point-of-sale terminal is operated by a vendor of the mobile telephone.

14. The method of claim 13, wherein the step of forwarding the activation information is performed by a point-of-sale central computer.

15. The method of claim 14, wherein the point-of-sale central computer is operated by a vendor of the mobile telephone or an independent third party.

16. A system for activating a mobile telephone comprising:
a processor operable to execute computer program instructions;
a memory operable to store computer program instructions executable by the processor; and
computer program instructions stored in the memory and executable to perform the steps of:
scanning a universal product code or an activation card associated with the mobile telephone to obtain activation information needed to activate the mobile telephone;
forwarding the activation information to a server database system; and
activating the mobile telephone at the server database system.

17. The system of claim 16, wherein the mobile telephone is a recyclable/disposable telephone.

18. The system of claim 17, wherein the information needed to activate the mobile telephone comprises:
information identifying the mobile telephone; and
routing information.

19. The system of claim 18, wherein the information needed to activate the mobile telephone further comprises:
information relating to a price paid to purchase the mobile telephone.

20. The system of claim 18, wherein the information identifying the mobile telephone comprises a Mobile Identification Number.

21. The system of claim 20, wherein the step of scanning a universal product code or an activation card is performed by a point-of-sale terminal.

22. The system of claim 21, wherein the point-of-sale terminal is operated by a vendor of the mobile telephone.

23. The system of claim 22, wherein the step of forwarding the activation information to a server database system is performed by a point-of-sale central computer.

24. The system of claim 23, wherein the point-of-sale central computer is operated by a vendor of the mobile telephone or an independent third party.

25. The system of claim 18, wherein the step of forwarding the activation information comprises the step of:
transmitting an activation message comprising the Mobile Identification Number.

26. The system of claim 25, wherein the step of transmitting the activation message comprises the step of:
transmitting the activation message to the server database system using the routing information.

27. The system of claim 26, wherein the step of scanning a UPC code or an activation card is performed by a point-of-sale terminal.

28. The system of claim 27, wherein the point-of-sale terminal is operated by a vendor of the mobile telephone.

29. The system of claim 28, wherein the step of forwarding the activation information is performed by a point-of-sale central computer.

30. The system of claim 29, wherein the point-of-sale central computer is operated by a vendor of the mobile telephone or an independent third party.

31. A computer program product for activating a mobile telephone comprising:
a computer readable medium;
computer program instructions, recorded on the computer readable medium, executable by a processor, for performing the steps of
scanning a UPC code or an activation card associated with the mobile telephone to obtain activation information needed to activate the mobile telephone;
forwarding the activation information to a server database system; and
activating the mobile telephone at the server database system.

32. The computer program product of claim 31, wherein the mobile telephone is a recyclable/disposable telephone.

33. The computer program product of claim 32, wherein the information needed to activate the mobile telephone comprises:
information identifying the mobile telephone; and
routing information.

34. The method of claim 33, wherein the information needed to activate the mobile telephone further comprises:
information relating to a price paid to purchase the mobile telephone.

35. The computer program product of claim 33, wherein the information identifying the mobile telephone comprises a Mobile Identification Number.

36. The computer program product of claim 35, wherein the step of scanning a UPC code or an activation card is performed by a point-of-sale terminal.

37. The computer program product of claim 36, wherein the point-of-sale terminal is operated by a vendor of the mobile telephone.

38. The computer program product of claim 37, wherein the step of forwarding the activation information to a server database system is performed by a point-of-sale central computer.

39. The computer program product of claim 38, wherein the point-of-sale central computer is operated by a vendor of the mobile telephone or an independent third party.

40. The computer program product of claim 33, wherein the step of forwarding the activation information comprises the step of:
transmitting an activation message comprising the Mobile Identification Number.

41. The computer program product of claim 40, wherein the step of transmitting the activation message comprises the step of:
transmitting the activation message to the server database system using the routing information.

42. The computer program product of claim 41, wherein the step of scanning a UPC code or an activation card is performed by a point-of-sale terminal.

43. The computer program product of claim 42, wherein the point-of-sale terminal is operated by a vendor of the mobile telephone.

44. The computer program product of claim 43, wherein the step of forwarding the activation information is performed by a point-of-sale central computer.

45. The computer program product of claim 44, wherein the point-of-sale central computer is operated by a vendor of the mobile telephone or an independent third party.

46. A system for activating a mobile telephone comprising:
a universal product code or an activation card associated with the mobile telephone, containing activation information needed to activate the mobile telephone;
a point-of sale terminal operable to scan the universal product code or activation card associated with the mobile telephone to obtain the activation information; and
a point-of-sale central computer operable to forward the activation information to a server database system in order to activate the mobile telephone.

47. The system of claim 46, wherein the mobile telephone is a recyclable/disposable telephone.

48. The system of claim 47, wherein the information needed to activate the mobile telephone comprises:
information identifying the mobile telephone; and
routing information.

49. The method of claim 48, wherein the information needed to activate the mobile telephone further comprises:
information relating to a price paid to purchase the mobile telephone.

50. The system of claim 48, wherein the information identifying the mobile telephone comprises a Mobile Identification Number.

51. The system of claim 50, wherein the point-of-sale terminal is operated by a vendor of the mobile telephone.

52. The system of claim 51, wherein the point-of-sale central computer is operated by a vendor of the mobile telephone or an independent third party.

53. The system of claim 48, wherein the activation information comprises the Mobile Identification Number.

54. The system of claim 53, wherein the point-of-sale central computer is operable to forward the activation information using the routing information.

55. The system of claim 55, wherein the point-of-sale terminal is operated by a vendor of the mobile telephone.

56. The system of claim 56, wherein the point-of-sale central computer is operated by a vendor of the mobile telephone or an independent third party.
